(19) United States
(12) Patent Application Publication
(10) Pub. No.: US 2025/0294656 A1
(43) Pub. Date: Sep. 18, 2025

(54) Enhanced Human Interface Lighting for Autonomous Machines

(71) Applicant: Applied Electric Vehicles Ltd, Scores by VIC (AU)

(72) Inventors: Marc Alexander, Croydon Hills (AU); Laksh Jaisinghani, Carrum Downs (AU)

(73) Assignee: Applied Electric Vehicles Ltd, Scores by VIC (AU)

(21) Appl. No.: 18/606,042

(22) Filed: Mar. 15, 2024

(51) Int. Cl. H05B 47/105; B60Q 1/14; B60Q 1/28; B60Q 1/30; B60Q 1/32; B60Q 1/50; B60W 60/00; F21S 41/125; F21S 41/13; F21S 41/141; F21S 43/14; F21W 102/40; F21Y 113/00; F21Y 113/13

(52) U.S. Cl. CPC H05B 47/105; B60Q 1/1423; B60Q 1/28; B60Q 1/30; B60Q 1/32; B60Q 1/503; B60Q 1/543; F21S 41/125; F21S 41/13; F21S 41/141; F21S 43/14; B60W 60/001; B60W 2554/4029; F21W 2102/40; F21Y 2113/13; F21Y 2113/30

(57) ABSTRACT

Enhanced human interface lighting for autonomous machines is described. In one or more implementations, a system includes perception sensor devices (e.g., camera systems, radar systems, lidar systems) to obtain environmental condition information for the environment around a vehicle. A vehicle control system controls the brightness or wavelength characteristics for one or more exterior lights of the vehicle based on the environmental condition information. In this way, the system improves driver and passenger safety, enhances the experience and safety of humans interacting with the vehicle, and improves the perception characteristics of the perception sensor devices.

### BACKGROUND

Vehicles generally include front and rear lighting to facilitate driving and enhance safety for the driver and other vehicles. These lighting schemes are generally limited to a predetermined brightness and wavelength. Such lighting schemes, however, do not always provide ideal lighting for various environments (e.g., night driving), weather conditions (e.g., fog), or driving objectives faced by the driver and/or vehicle. In addition, most vehicles lack side lighting to improve user experience and safety for passengers and nearby pedestrians.

### BRIEF DESCRIPTION OF THE DRAWINGS

FIGS. 1A and 1B illustrate non-limiting example environments, respectively, in which a vehicle provides enhanced human interface lighting.

FIG. 2 is a block diagram of a non-limiting example of a vehicle system that implements enhanced human interface lighting.

FIG. 3 depicts an example block diagram for providing enhanced human interface lighting in a vehicle.

FIG. 4 is an environment illustrating a non-limiting example of a vehicle system that enables enhanced human interface lighting via an application on an external computing device.

FIG. 5 depicts a procedure for implementing enhanced human interface lighting for autonomous machines.

### DETAILED DESCRIPTION

Modern vehicles include various exterior lights, including headlights and taillights. They also include various headlights (e.g., low-beam, high-beam, and fog lights). Some vehicles also include side lights that light up a small area immediately below an open door. These various exterior lights, however, are limited to a fixed or predetermined brightness and wavelength and generally are not dynamically controlled to adapt to improving safety, sensor perception, or user experience.

In accordance with the techniques of this disclosure, this document describes enhanced human interface lighting for autonomous machines, including autonomous vehicles and semi-autonomous vehicles. An example system includes multiple perception sensor devices, which may include camera systems, radar systems, and lidar systems, that obtain environmental condition information for the environment around the vehicle, user interaction objectives, or contextual information. The environmental condition information may indicate weather conditions (e.g., foggy, rainy), ambient light conditions (e.g., sunset, dusk, nighttime), or other conditions impacting user safety, driver experience, or sensor integrity. The user interaction objectives may include a vendor or brand's color preference, contextual information about the interaction or transaction with the user (e.g., delivery pickup, passenger drop off). The system can also determine the current time, a driving objective (e.g., highway driving, package delivery, parking lot maneuvering), or perception sensor quality. Based on the environmental condition information and/or other information, a vehicle control system (e.g., a body control device) can control the brightness or wavelength characteristics of one or more exterior lights. As one example, the vehicle control system controls an array of light sources (e.g., laser or coherent light sources, projectors, single wavelength laser or coherent light sources, multi-wavelength laser or coherent light sources, LED bulbs) for the headlights to vary the brightness and wavelength characteristics of the emitted light for different distances in front of the vehicle to improve driver visibility in low-light conditions. Similarly, the brightness or wavelength of the headlights can be adjusted to improve a camera system's visual perception of the road ahead. These systems and techniques improve driver and passenger safety, enhance user experience, and improve the perception sensor devices' perception characteristics.

In another example implementation, a vehicle can include side lights (e.g., radial lighting arrays that create addressable zones of illuminated pixel projections onto the ground and other surfaces around the vehicle). When an autonomous delivery vehicle (e.g., carrying packages, groceries, or similar items) arrives at a person's home or business, the vehicle control system controls the side lights to project a light trail from the front door of the delivery address to the vehicle, especially if it is dark outside. The vehicle can also take advantage of side cameras to adapt the location of the light trail to go around obstacles (e.g., a tree), follow a sidewalk, or follow a person approaching the delivery address. In other scenarios, the side lights can project an advertisement for other services available. For example, if groceries are being delivered, the vehicle can project an advertisement for take-out food available in another vehicle bin. In this way, the described techniques and systems improve user experience and safety.

Similarly, the described systems and techniques can improve safety for pedestrians, other vehicles, and cyclists. For example, if the vehicle is shifted into reverse or drive, exterior lights can project a red or other warning light envelope around the vehicle to act as a warning to pedestrians, cyclists, and others that the vehicle may soon drive over the light envelope (e.g., warning lights toward the rear of the vehicle to alert pedestrians and vehicles passing by its rear). If a user selects an input to open a tailgate or door, lights can be projected behind or to the side of the vehicle, respectively, to alert pedestrians or cyclists of an impending device opening. In another example, if the vehicle is an autonomous vehicle (e.g., with no driver) and stopped at a stop sign or stoplight, a green (or other color) light or an image (e.g., pedestrian crossing image) can be projected onto the ground to indicate that the pedestrians may cross and that the autonomous vehicle is aware of their presence. As the pedestrian clears the front of the vehicle, the projected light can change colors (e.g., to red) or shape (e.g., red hand) to indicate to pedestrians not to cross in front of the vehicle because it is about to proceed.

In some aspects, the techniques described herein relate to a system comprising one or more perception sensor devices configured to obtain environmental condition information for an environment near a vehicle and a vehicle control system having one or more processors configured to control brightness or wavelength characteristics for one or more exterior lights of the vehicle based on the environmental condition information.

In some aspects, the techniques described herein relate to a system wherein the exterior lights include an array of multi-wavelength light emitters and each multi-wavelength light emitter has adjustable brightness or wavelength characteristics.

In some aspects, the techniques described herein relate to a system wherein the one or more processors are further configured to control two or more subsets of the array of multi-wavelength light emitters to emit light with different brightness or wavelength characteristics from one another.

In some aspects, the techniques described herein relate to a system wherein the array of multi-wavelength light emitters is located on at least one of a rear, front, corner, side, or bottom of the vehicle.

In some aspects, the techniques described herein relate to a system wherein the array of multi-wavelength light emitters is located on the front of the vehicle and the one or more processors are further configured to control multiple subsets of the array of multi-wavelength light emitters to emit light with different brightness or wavelength characteristics at different longitudinal distances in front of the vehicle.

In some aspects, the techniques described herein relate to a system wherein the array of multi-wavelength light emitters is located on the side of the vehicle and the one or more processors are further configured to control a subset of the array of multi-wavelength light sources to emit a light trail extending away from the side of the vehicle, provide ambient lighting, or display an advertisement on a ground surface near the vehicle.

In some aspects, the techniques described herein relate to a system wherein the one or more processors are further configured to control a subset of the array of multi-wavelength light emitters to emit a light strip on a surface near the vehicle in response to the vehicle being placed in drive or reverse, the light strip configured to provide a warning to nearby pedestrians, vehicles, or other objects that the vehicle is prepared to move.

In some aspects, the techniques described herein relate to a system wherein the multi-wavelength light emitters are configured to emit light within at least two of a visible light spectrum, an ultraviolet light spectrum, or an infrared light spectrum.

In some aspects, the techniques described herein relate to a system wherein the one or more processors are further configured to control at least a subset of the multi-wavelength light emitters to emit ultraviolet light or infrared light to communicate information to nearby vehicles regarding at least one of a status of the vehicle, an upcoming driving maneuver of the vehicle, or an obstacle in a roadway.

In some aspects, the techniques described herein relate to a system wherein each multi-wavelength light emitter is a light emitting diode.

In some aspects, the techniques described herein relate to a system wherein the one or more processors are further configured to obtain an objective for the vehicle, including a driving objective from an autonomous-or semi-autonomous-driving system or a user interaction objective from one or more data platforms of the vehicle and control the brightness or wavelength characteristics for the one or more exterior lights based on the environmental condition information and the driving objective.

In some aspects, the techniques described herein relate to a system wherein the one or more processors are further configured to obtain feedback data from at least one of the one or more perception sensor devices, the feedback data indicating a perception quality of recent data collections, and control the brightness or wavelength characteristics for the one or more exterior lights based on the environmental condition information and the feedback data.

In some aspects, the techniques described herein relate to a system wherein the environmental condition information includes at least one of ambient light information, weather condition information, road surface conditions, or information regarding nearby objects.

In some aspects, the techniques described herein relate to a system wherein the one or more processors are further configured to in response to detecting a pedestrian crossing in front of the vehicle and an autonomous-driving subsystem determining to not proceed driving, control the one or more exterior lights to emit a light strip indicating that the vehicle notices the pedestrian and will not proceed, and in response to detecting the pedestrian has finished crossing in front of the vehicle and the autonomous-driving subsystem determining to proceed driving, control the one or more exterior lights to emit another light strip indicating that the vehicle will proceed driving.

In some aspects, the techniques described herein relate to a vehicle control system of a vehicle comprising one or more processors configured to obtain, from one or more perception sensor devices, environmental condition information for an environment around the vehicle, and control, based on the environmental condition information, brightness or wavelength characteristics for one or more exterior lights of the vehicle.

In some aspects, the techniques described herein relate to a vehicle control system wherein the exterior lights include an array of multi-wavelength light emitters, each multi-wavelength light emitter having adjustable brightness or wavelength characteristics, and the one or more processors are further configured to control two or more subsets of the array of multi-wavelength light emitters to emit light with different brightness or wavelength characteristics from one another.

In some aspects, the techniques described herein relate to a vehicle control system wherein the one or more processors are further configured to control the array of multi-wavelength light emitters to emit light with different brightness or wavelength characteristics based on at least one of a longitudinal distance from a front of the vehicle or a lateral distance from a center of the vehicle.

In some aspects, the techniques described herein relate to a vehicle control system wherein the one or more processors are further configured to control a subset of the array of multi-wavelength light sources to emit a light trail extending away from a side of the vehicle, provide ambient lighting, or display an advertisement on a ground surface near the vehicle.

In some aspects, the techniques described herein relate to a vehicle control system wherein the one or more processors are further configured to control a subset of the array of multi-wavelength light emitters to emit a light strip on a surface near the vehicle in response to an input to open a door or rear hatch of the vehicle to provide a warning to nearby pedestrians, vehicles, or other objects that the door or the rear hatch will open.

In some aspects, the techniques described herein relate to a computer-readable storage medium comprising instructions that, when executed by one or more processors, cause a vehicle control system of a vehicle to: determine an objective for the vehicle, the objective including a driving objective from one or more autonomous- or semi-autonomous driving systems, a user interaction objective from one or more data platforms, or contextual information from one or more perception sensor devices or the one or more data platforms; determine brightness or wavelength characteristics for one or more exterior lights of the vehicle based on the environmental condition information and the driving objective; and control the one or more exterior lights to emit light according to the brightness or wavelength characteristics.

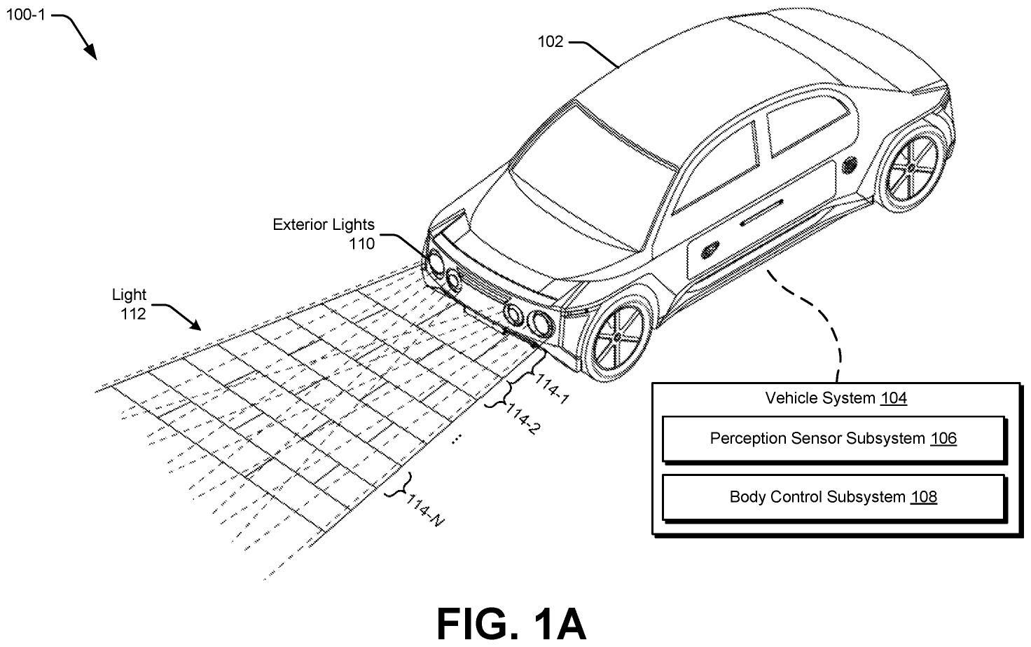

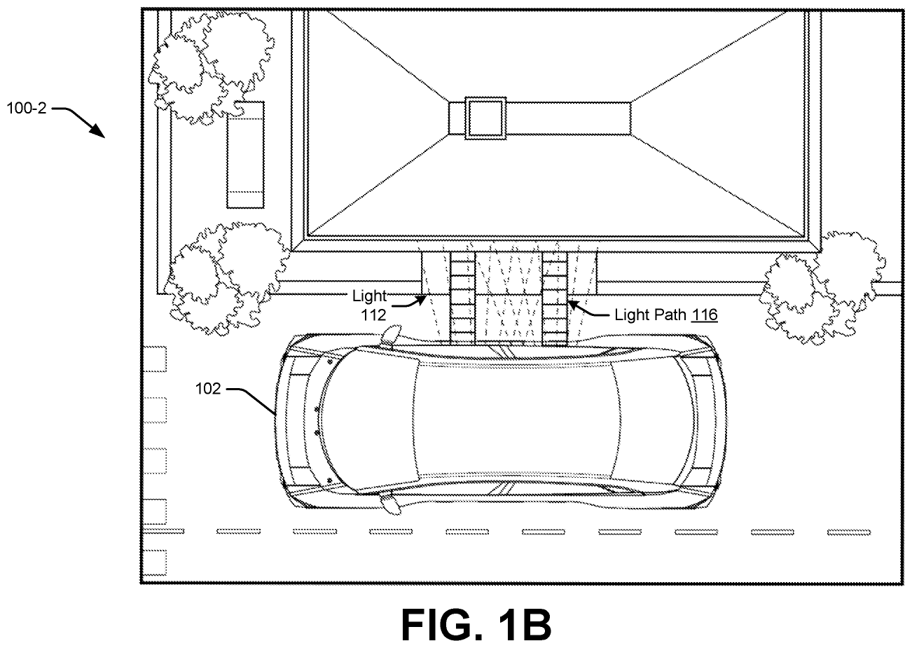

FIGS. 1A and 1B illustrate non-limiting example environments 100-1 and 100-2, respectively, in which a vehicle 102 provides enhanced human interface lighting. The environments 100-1 and 100-2 include any type of vehicle operating environment, such as a roadway, a traffic scenario, an off-road area (e.g., a construction site, a mining operation, or a recreational area), in the air, on or in the water, on or in other substances (e.g., within fluids and/or cellular material), in space, and other public or private spaces, to name a few. The vehicle 102 may be any type, including ground vehicles (e.g., trucks, cars, vans, tractor-trailers, tanks), air vehicles, rail vehicles, marine vehicles, space vehicles, or other vehicle types. Vehicle 102, in at least one example, is unmanned (e.g., autonomously controlled, remotely controlled), and in at least one other example, vehicle 102 is manned (e.g., semi-autonomously controlled, at least partially human operated).

The vehicle 102 includes a vehicle system 104, which generally includes multiple electronic systems configured to interface with electro-mechanical components of the vehicle 102 to implement processor-based vehicle functions and processor-driven operations, such as exterior lighting in the environment 100-1 or 100-2 or for driving or maneuvering the vehicle 102 in the environment 100-1 or 100-2.

The vehicle system 104 includes a vehicle network that operatively couples a plurality of vehicle subsystems to a control system. For example, the vehicle subsystems represent a plurality of edge devices on the vehicle 102, which are in communication with the vehicle network and the control system to control vehicle components that operate in coordination to execute vehicle operations based on the network communication.

Examples of the vehicle subsystems include but are not limited to a perception sensor subsystem 106 (e.g., providing environmental condition information about the environment 100-1 or 100-2) and body control subsystem 108 (e.g., for controlling exterior lights 110 of the vehicle 102). The perception sensor subsystem 106 may also provide sensor fusion and enable radar-based, lidar-based, camera-based, or other sensor-based control of the vehicle 102 or any vehicle subsystems. The body control subsystem 108 may also control cabin environment conditions, interior and exterior vehicle lights, vehicle doors and latches, precipitation wipers, power or climate-controlled seating.

More specifically, the perception sensor subsystem 106 includes various sensors to obtain information about the environment around the vehicle 102. The sensors may include camera systems, radar, lidar, thermometers, and/or ambient light sensors. Camera systems collect images of the environment within its field of view. For example, camera systems are used in many vehicles to provide a video feed (e.g., rearview camera feed) to the driver, lane detection, and traffic sign recognition, along with other tasks. Radar and lidar sensors are commonly used to assist with blind spot detection, lane change assistance, collision mitigation, parking assistance, and other Advanced Driver Assistance Systems (ADAS). Thermometers are used to indicate the outside temperature. Ambient light sensors detect variable lighting conditions in the driving environment.

Other examples of vehicle subsystems include a propulsion or motion subsystem (e.g., providing motion control), drive subsystem (e.g., providing autonomous or semi-autonomous motion control), transmission subsystem, powertrain subsystem, human-machine interface (HMI) subsystem (e.g., for receiving driver input, for receiving occupant input, for controlling in-vehicle infotainment), remote entry or remote start subsystem, braking subsystem (e.g., providing brake control), an electronic stability control (ESC) subsystem, and communication subsystem for handling on-board and/or offboard communications (e.g., data and telemetry, vehicle-to-vehicle, vehicle-to-everything, cellular, Bluetooth). Further examples include but are not limited to an ADAS, steering subsystem (e.g., providing steering control), active suspension subsystem, fuel management subsystem, battery management subsystem (e.g., providing traction energy, managing battery usage and charging control), power distribution subsystem, subsystem), alarm subsystem, payload subsystem, and extensible-assembly control subsystem (e.g., pod control, exterior tool control), and any other electronic-based subsystem of the vehicle 102 that is controllable by the control system.

The vehicle system 104 includes one or more central control units that are electronic circuits for processing instructions to execute control routines on the vehicle. In particular, processor execution of the control routines enables the central control units to manage vehicle operations implemented by the edge devices, including the perception sensor subsystem 106 and the body control subsystem 108. The central control units and edge devices include a memory that stores instructions for execution by the processors to redundantly control the vehicle operations or implement vehicle functions in furtherance of the vehicle operations. For example, the central control units and/or the edge devices each include a memory circuit that stores instructions and data for executing a program (e.g., software, firmware). In one or more implementations, the memory corresponds to semiconductor memory, where data is stored within memory cells on one or more integrated circuits. The respective memory of each central control unit and/or edge device is used to store information, such as for immediate output to the vehicle network.

In at least one example, the memory of the central control units and/or the edge devices corresponds to or includes volatile memory, examples of which include random-access memory (RAM), dynamic random-access memory (DRAM), synchronous dynamic random-access memory (SDRAM), static random-access memory (SRAM), and memristors. The memory of each of the central control units and/or the edge devices is configurable with any number of memory (e.g., physical memory) without departing from the spirit or scope of the described techniques. Alternatively or in addition, the memory of each of the central control units and/or the edge devices corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto-resistive random-access memory (MRAM). Further examples of memory configurations include low-power double data rate (LPDDR), also known as LPDDR SDRAM. The memory of each central control unit and/or edge device is configurable in various ways to support vehicle controls.

As depicted in FIG. 1A, the perception sensor subsystem 106 obtains environmental condition information for the environment 100-1. For example, the perception sensor subsystem 106 includes a camera system, thermometer, and/or ambient light sensor to determine weather conditions, driver visibility, and/or sensor visibility for the environment 100-1. In another example, the vehicle system 104 generates or obtains one or more driving objectives (e.g., autonomous-driving objectives, assisted-driving objections), user interaction objectives, and/or contextual information. In response to the environmental condition information driving objectives, user interaction objectives, and/or contextual information, the body control subsystem 108 controls the brightness and/or wavelength characteristics of one or more exterior lights 110 to provide light 112 into the environment 100-1. In this way, exterior lighting is provided to improve the physical interaction between the vehicle 102 and one or more users. In particular, the body control subsystem 108 controls the exterior lights 110 to personalize or crafts the light 112 to suit the user or vendor's color preferences, highlight certain elements to be aware of or to interact with, or dynamically change its illumination behavior depending on the context of the driving, interaction, or transaction (e.g., any of which may be provided via off-vehicle or on-vehicle e-commerce or data platform).

In FIG. 1A, the exterior lights 110 are depicted as headlights on the front portion of vehicle 102. In this or other implementations, the exterior lights 110 may also be taillights (e.g., installed on a rear portion of the vehicle 102), side lights (e.g., installed to project lighting towards one or both sides of the vehicle 102), corner lights, or bottom lights (e.g., installed on or near a bottom portion of the vehicle 102 to project light onto the ground around the vehicle 102). The exterior lights 110 generally include an array (e.g., one-dimensional or two-dimensional array) of individual multi-wavelength light emitters (e.g., light emitting diode (LED) bulbs, ultraviolet (UV) bulbs, or infrared (IR) bulbs). In other words, the exterior lights 110 may be able to emit light within at least two of a visible light spectrum, UV light spectrum, or IR light spectrum. In other implementations, the exterior lights 110 may also include laser or coherent light sources, projectors, single wavelength or multi-wavelength laser or coherent light sources. In some implementations, the laser emitters are coherent LEDs. The body control subsystem 108 controls the individual light emitters to emit light with a particular brightness or wavelength characteristic from a range of available brightness and/or wavelength characteristics. In particular, the intensity of anyone of blue (B), green (G), red (R), yellow (Y), white (W), UV, IR, or other light wavelengths can be varied for individual light emitters to shift the brightness or wavelength characteristics of the exterior lights 110. For example, multi-wavelength light emitters may include RGB or RGBW emitters, which mix aspects of red, green, blue, and/or white emitters to achieve a specific color temperature of white light (e.g., between 2000 and 6500 K) to illuminate an object or area with sufficient brightness or color temperature. In addition, white light can be mixed in with one of R, G, B, and/or Y LEDs to provide pastel colors at higher brightness levels than a single color emitter alone.

The individual light emitters of the array can be oriented to project light 112 to a specific area, which is illustrated as a rectangle within the light 112 in FIG. 1A. For example, the light emitters in the array can be oriented to provide the light 112 with different brightness or wavelength characteristics within each area (e.g., the rectangles of FIG. 1A).

It should be noted that the lit area for each emitter can have a different shape and size than illustrated in FIG. 1A. Instead of individually orienting each light emitter of the array, the exterior lights 110 may use a combination of actuators and/or lenses to generate a similar effect as illustrated with the rectangles in FIG. 1A.

In response to the environmental condition information, the body control subsystem 108 controls the exterior lights 110 to emit light with particular brightness and/or wavelength characteristics. For example, the individual light emitters of the exterior lights 110 emit light in front of the vehicle 102 with a brightness or wavelength characteristic determined based on the environmental condition information. The body control subsystem 108 can control a first subset of the light emitters to emit light with a first brightness or wavelength characteristics for a first distance range 114-1 in front of vehicle 102. Similarly, second and Nth brightness or wavelength characteristics may be emitted for a second distance range 114-2 and an Nth distance range 114-N, respectively. In this way, different brightness and/or wavelength characteristics may be emitted for the different distance ranges 114 in front of vehicle 102, which may improve visibility for the driver in low-light or dark conditions.

In another implementation, the brightness and wavelength characteristics may also vary based on a lateral distance from a longitudinal axis extending in front of vehicle 102 from the center of vehicle 102. In this way, the vehicle system 104 provides improved visibility for the driver and/or perception sensors based on detected weather conditions, environmental conditions, ambient light, the time of day, driving objectives, and/or autonomous driving objectives.

In FIG. 1B, the exterior lights 110 (not shown due to the top view) are sidelights or corner lights on the passenger side of vehicle 102. The sidelights and corner lights can include radial lighting arrays that create addressable or programmable zones of illuminated pixel projections onto the ground and other surfaces around vehicle 102 in any direction. The maximum distance of the light projections away from vehicle 102 generally depends on the distance capability of the light source making up the exterior lights 110. The surfaces onto which the exterior lights 110 project include the ground, steps up to a property entrance, nearby trees or objects, or other surfaces that require further illumination for vehicle camera systems to be able to resolve and recognize or to provide better illumination for a user.

Similar to the headlights in FIG. 1A, the body control subsystem 108 can control the exterior lights 110 to emit light with particular brightness and/or wavelength characteristics at different locations within the light 112. In the illustrated example of FIG. 1B, the individual light emitters illuminate the area between the vehicle 102 and a nearby building. The body control subsystem 108 can control a subset of the light emitters to emit light to display one or more light paths 116 (e.g., from the front door of a person's house to the passenger doors) with first brightness and wavelength characteristics. Information from perception sensor subsystem 106 can indicate objects (e.g., trees), which can be used to project the light paths 116 around such objects. Information from ADAS or a navigation subsystem can indicate to which house or building the light path 116 should extend. Second brightness and wavelength characteristics can be used to illuminate the additional side area near the vehicle 102. In this way, the vehicle system 104 provides improved visibility, user experience, and/or safety for a passenger or someone being picked up.

In another example implementation, the sidelights of an autonomous delivery vehicle (e.g., carrying packages, groceries, or similar items) provide the light path(s) 116 when it arrives at a person's home or business. The light path 116 provides a more welcoming experience for autonomous deliveries. In addition, the light 112 can improve safety by lighting up a dark or poorly lit area. In other scenarios, the side lights can advertise other services beside or along the light path 116. For example, if a person had groceries delivered, the vehicle 102 can advertise take-out food (e.g., ramen) in another vehicle bin.

Similarly, the body control subsystem 108 can use the exterior lights 110 to improve safety for pedestrians, other vehicles, and cyclists. For example, if the vehicle is shifted into reverse or drive, exterior lights can project a red or other warning light envelope or strip around the vehicle to act as a warning to pedestrians, cyclists, and others that the vehicle may soon drive over the light envelope. If a user selects an input to open a tailgate or door, the body control subsystem 108 can project lights behind or to the side of the vehicle, respectively, to alert pedestrians or cyclists of an impending device opening. In another example, if the vehicle is an autonomous vehicle (e.g., with no driver) and stopped at a stop sign or stoplight, the body control subsystem 108 can project lights (e.g., a particular color or image) on the roadway in front of the vehicle 102 to indicate that the pedestrians may cross and that the ADAS is aware of their presence. As the pedestrian clears the front of the vehicle, the projected light can change color (e.g., to red) or shape (e.g., red hand) to indicate that the vehicle 102 is about to proceed.

In another implementation, the exterior lights 110 can also emit light not visible to humans (e.g., UV or IR light). The non-visible light can be configured (e.g., pulses, shapes, intensities, etc.) to communicate information to nearby vehicles. For example, the vehicle 102 can indicate that it will soon make a lane change to provide advance notice to other vehicles. Similarly, if an unexpected object is detected in a roadway (e.g., a pedestrian or debris) that a trailing vehicle may not be able to sense, vehicle 102 can provide an indication of the object and its planned evasive maneuver to the trailing vehicle.

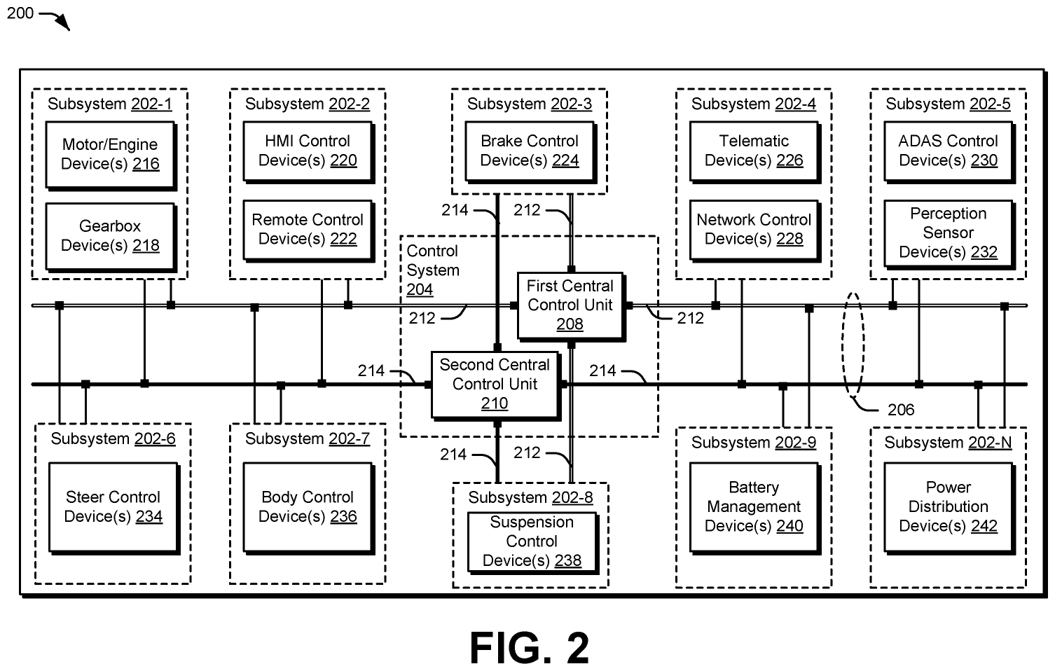

FIG. 2 is a block diagram of a non-limiting example of a vehicle system 200 that implements enhanced human interface lighting. For ease of description, the vehicle system 200 is described in the context of the environments 100-1 and 100-2 shown in FIGS. 1A and 1B, respectively, including with reference to similarly labeled elements. For example, the vehicle system 200 is a more detailed version of the vehicle system 104 installed in the vehicle 102. The vehicle system 200 includes a plurality of subsystems 202 (labeled individually as subsystem 202-1 through subsystem 202-N, where N is any integer) managed by a control system 204 to implement various vehicle functions. The vehicle subsystems 202 are distributed on the vehicle 102 and include one or more edge devices. In at least one example, the vehicle system 200 includes additional or fewer subsystems 202 than those depicted in FIG. 2.

The control system 204 is configured as a centralized controller that enables information to transfer between the subsystems 202 over a network 206 (e.g., a vehicle network). By exchanging information with the subsystems 202, the control system 204 causes the subsystems 202 to execute subsystem functions that enable driving. For instance, the control system 204 receives signals output on the network 206 from one of the subsystems 202, and based on information inferred from the signals, the control system 204 outputs additional signals on the network 206 to cause a particular behavior of another of the subsystems 202.

The control system 204 includes at least two central control units 208 and 210. The control system 204 and the central control units 208, 210 are centrally located on the vehicle 102 relative the edge devices and the vehicle subsystems 202, in at least one example. In at least one other example, the control system 204 is positioned on the vehicle 102 closer to one or more edge devices and the vehicle subsystems 202 than others. In other implementations, the control system 204 includes a single central control unit or other processing device.

The control system 204 includes a first central control unit 208 and a second central control unit 210. The first central control unit 208 and the second central control unit 210 represent separate processors, processor cores, control units, microcontrollers, systems on chip, or other processor technology. Each central control unit 208, 210 is configured to execute instructions either as software or firmware to implement functionality of the control system 204. Although not shown, in some examples, the control system 204 includes a non-transitory computer-readable storage medium (e.g., data store, cache, static memory, dynamic memory, flash memory, disk storage) that maintains the instructions and data for implementing the instructions executed by each of the first central control unit 208 and the second central control unit 210. For example, the first central control unit 208 and the second central control unit 210 include respective data stores that contain the instructions retrieved from the data stores and executed during the operation of vehicle 102.

Examples of the processors of the central control units 208, 210 and/or the edge devices include but are not limited to a central processing unit (CPU), graphics processing unit (GPU), field programmable gate array (FPGA), accelerator, accelerated processing unit (APU), and system on chip (SoC), microcontroller, electronic control unit (ECU), and digital signal processor (DSP), to name a few. In one or more variations, the processors of the central control units 208, 210 and/or the edge devices include multiple co-processors or multiple cores (e.g., a multi-core processor). In one or more other variations, the processors of the central control units 208, 210 and/or the edge devices include only one core (e.g., a single processor core).

In one or more implementations, the central control units 208, 210 include the same hardware technology. For example, the first central control unit 208 and the second central control unit 210 have identical processor technology. In one or more other implementations, the central control units 208, 210 include different hardware configurations that implement the same functionality. For example, a processor of the first central control unit 208 and the second central control unit 210 have different processor technology configured to execute identical control routines.

In another implementation, the control system 204 is distributed throughout the vehicle system 200 in two or more locations. In such a distributed implementation, the first central control unit 208 is included in a first part of the control system 204 arranged at one part of the vehicle 102 (e.g., a front portion) and the second central control unit 210 is included in a second part of the control system 204 positioned at another part of the vehicle 102 (e.g., a rear portion). In other distributed implementations, each part of the control system 204 includes one or more multiple instances of the first central control unit 208 and/or the second central control unit 210.

In one or more examples, the first central control unit 208 and the second central control unit 210 are functionally redundant. For example, the processors of each of the first central control unit 208 and the second central control unit 210 are operable to concurrently receive the same set of inputs from the subsystems 202 and concurrently send the same set of outputs to the subsystems 202. Similarly, the processors of each of the first central control unit 208 and the second central control unit 210 are operable to concurrently receive the same set of inputs from the subsystems 202 and concurrently send the same set of outputs to the subsystems 202 regardless of whether that processor is the healthiest.

The subsystems 202 of the vehicle system 200 rely on equivalent control operations of either the first central control unit 208 or the second central control unit 210 (e.g., one at a time) to actively cause vehicle operations or vehicle functions to be performed by the subsystems 202. For example, while the first central control unit 208 is orchestrating operations of the subsystems 202, the second central control unit 210 is maintained in a ready, standby state. If the first central control unit 208 fails, then the control system 204 activates the second central control unit 210 to take over and manage the subsystems 202 where the first central control unit 208 left off. When the second central control unit 210 takes over, the vehicle 102 may be forced to operate in a safe state, which can include maneuvering away from other vehicles, objects, and pedestrians to come to a controlled stop. This way, the functional redundancy implemented by the first central control unit 208 and the second central control unit 210 helps the control system 204 satisfy the ASIL-D requirements for reliability and safety. In such implementations, the first central control unit 208 and the second central control unit 210 may be located at different locations within the vehicle.

The network 206 represents any suitable vehicle network technology, including wired and wireless signal propagation mediums. The network 206 enables real-time data exchange, safety enhancements, and efficient traffic management among the components of the vehicle system 200. Network 206 can include various switches, routers, transceivers, controllers, chokes, filters, terminations, and other networking equipment beyond transmission lines, cables, wires, buses, and other signal-routing technologies. In an aspect, the network 206 adheres to an in-vehicle networking protocol. For example, the network 206 represents a combination of one or more of a controller area network (CAN), automotive ethernet network (AEN), serializer/deserializer (SerDes) network, local interconnect network (LIN), or FlexRay network (FRN).

In at least one example, to implement the redundancy of the control system 204, the network 206 includes dual physical network paths or network channels. In at least one example, the first central control unit 208 and the second central control unit 210 are operable to concurrently exchange the same set of inputs and outputs with the subsystems 202 over different respective channels (e.g., logical or physical channels) of the network 206 that link the subsystems 202 to that central control unit (e.g., processor). A network channel 212 or network path communicatively couples subsystems 202 to the first central control unit 208. A separate network channel 214 or network path communicatively links subsystems 202 to the second central control unit 210. For example, the network channel 212 is utilized by the first central control unit 208 to exchange data over the network 206, and the network channel 214 is utilized by the second central control unit 210 to exchange data over the network 206. In at least one implementation, if a failure at the first central control unit 208 is at least partially caused by a fault in the network channel 212, the second central control unit 210 is unaffected by the network fault and operable to communicate with the subsystems 202 using the network channel 214. The functional redundancy implemented by network channel 212 and network channel 214 further helps control system 204 to satisfy the ASIL-D requirements for reliability and safety.

In at least one other example, to implement the redundancy of the control system 204, the network 206 includes dual logical network paths or channels. The network channel 212 and the network channel 214 may be separate logical paths through the network 206 that communicatively link each subsystem 202 to the first central control unit 208 and the second central control unit 210 using the same physical wires. In at least one example, the first central control unit 208 and the second central control unit 210 are operable to interleave the same set of inputs and outputs concurrently exchanged with the subsystems 202 over the same set of channels (e.g., logical or physical channels) of the network 206 that link the subsystems 202 to that central control unit (e.g., processor). For example, communications two and from the first central control unit 208 and the second central control unit 210 are interleaved on a single set of wires that make up the network 206. If a failure at the second central control unit 210 and/or the network channel 214 occurs, communications from the first central control unit 208 can reach the subsystems 202 using the network channel 212. The functional redundancy implemented by interleaving network channel 212 and network channel 214 further helps the control system 204 to satisfy the ASIL-D requirements for reliability and safety.

Each subsystem 202 includes one or more edge devices operatively coupled to the network 206 to provide information to the control system 204 and receive commands from the control system 204 to implement various vehicle functions. For example, each subsystem 202 can include one or more actuators, microcontrollers, machines, or other equipment to perform specific vehicle tasks at the control of the edge devices that are contained within subsystem 202.

A subsystem 202-1 is a propulsion or drive subsystem. Motor/engine devices 216 of the subsystem 202-1 represent edge devices managed by the control system 204 to command vehicle propulsion units (e.g., an engine, a motor) to execute driving functions of the vehicle 102 (e.g., forward motion, reverse motion, acceleration, deceleration). In one or more examples, the motor/engine devices 216 manages operations of an engine of vehicle 102, including fuel injection, ignition timing, emissions control, and engine health monitoring. In at least one aspect (e.g., for electric vehicles), the motor/engine devices 216 control inverters and motors that convert electric energy into mechanical energy for applying torque to wheels.

In addition, the subsystem 202-1 includes gearbox devices 218. Also referred to as a powertrain control module (PCM) and/or a transmission control module (TCM), transmission and gearbox functions are overseen by the gearbox devices 218 to implement an automatic transmission, optimize gear changes (e.g., gear shifts), and control torque delivered to the wheels of the vehicle 102. A vehicle may include one or more instances of subsystem 202-1 (e.g., one subsystem 202-1 for each axle).

A subsystem 202-2 is a human-machine interface (HMI) subsystem. The subsystem 202-2 includes one or more HMI control devices 220 that implement a vehicle user interface. The vehicle user interface enables interaction between occupants (e.g., driver, passenger, user) of the vehicle 102 and the vehicle system 200, which enables human intervention and control of vehicle functions and driving. For example, the HMI control devices 220 control vehicle displays, vehicle dash clusters, head-up display units, haptic feedback, audible feedback, and other visual driving aids interpreted by the occupants to help with driving or ensuring safe vehicle operations. In one or more implementations, the HMI control devices 220 provide a human interface to control climate controls (e.g., heating, cooling), cabin features (e.g., infotainment, interior lighting), and other vehicle body features (e.g., windshield wipers, transmission settings, suspension settings, drive mode selection, power seating, power mirrors, power door locks).

The subsystem 202-2 also includes one or more remote control devices 222 that allow human or machine inputs to control the vehicle 102 from outside the cabin.

For example, in an autonomous or semi-autonomous vehicle context, the remote control devices 222 receive commands over a communication link with a base station (e.g., a mobile phone, a key fob, a remote computing system) to allow a human or machine operator to control the vehicle 102 as if the driving commands are provided directly to the HMI control devices 220. In hot or cold weather, the remote control devices 222 activate remote starting functions to pre-cool or pre-heat the cabin. In at least one aspect, the remote control devices 222 allow door locks to be unlocked or locked and doors, tailgates, or trunks to be remotely opened or closed.

A subsystem 202-3 represents a braking subsystem of the vehicle system 200. For example, one or more brake control devices 224 are operable to manage anti-lock braking systems (ABS), electronic stability controls (ESC), and otherwise convert driver inputs at the HMI control devices 220 to control vehicle brakes (e.g., for stopping, for decelerating). In some examples, the brake control devices 224 represent a braking control module (BCM).

A subsystem 202-4 is an onboard-vehicle communication subsystem, which manages telematics and communications that occur within the vehicle 102 and with other devices located outside the vehicle 102. For example, the subsystem 202-4 interfaces with the various edge devices coupled to the network 206 to ensure a healthy exchange of data free of errors or faults. In addition, the subsystem 202-4 interfaces with other vehicles, mobile devices, infrastructure, and remote computing systems to implement various vehicle functions. One or more network control devices 228 of subsystem 202-4 monitor network health of network 206 and facilitate communication protocols implemented therein. The network control devices 228 are configured to diagnose problems with the network 206 to reroute signals and prevent data loss.

One or more telematic devices 226 of the subsystem 202-4 handle offboard or external communications of the vehicle 102. This includes implementing vehicle-to- vehicle (V2V) and vehicle-to-everything (V2X) communications that enable the vehicle 102 to communicate with other intelligent vehicles and systems in an operating environment (e.g., on or near a roadway). The telematic devices 226 interface with over-the-air (OTA) update services to update the software on the vehicle 102. In addition, the telematic devices 226 interface with a positioning system to assist with navigation functions. Other features implemented by the telematic devices 226 include remote diagnostics and interfacing with emergency response services (e.g., to alert emergency responders in the event of an accident automatically).

A subsystem 202-5 is an advanced driving and safety (ADAS) subsystem of the vehicle system 200. The subsystem 202-5 has two main functions, including implementing an ADAS and a perception sensor system. For example, one or more ADAS control devices 230 implement ADAS functionality that includes autonomous or semi-autonomous control, adaptive cruise control, emergency braking, lane centering, and other ADAS functions. One or more perception sensor devices 232 support the ADAS control devices 230 by providing information about the driving environment to ensure safe driving. For example, a radar, a camera, a lidar, an ultrasonic sensor, a global position system (GPS) sensor, an inertial measurement unit (IMU), and other sensor technology are deployed by the perception sensor devices 232 to collect sensor data about a vehicle environment. Sensor fusion techniques, object detection, lane centering, path trajectory planning, and other perception sensor functions are executed by the perception sensor devices 232 to enable ADAS control devices 230 to perform ADAS functions.

A subsystem 202-6 is a steering subsystem that controls elements of the vehicle to steer the wheels. One or more steer control devices 234 integrate with an electric power steering system of the vehicle 102 to control the direction of the vehicle wheels. The steer control devices 234 receive inputs from the HMI control devices 220 and/or the control system 204, which are translated into appropriate steering commands for controlling steering actuators that change the wheels' direction for steering and performing evasive maneuvers.

A subsystem 202-7 represents a body control subsystem of the vehicle 102. Included in the subsystem 202-7 are one or more body control devices 236, which oversee functions related to vehicle body controls. For example, window actuators, door locks and latches, interior and exterior lighting, tailgate and trunk latches, and the like are controlled by the body control devices 236 at the command of the control system 204 and/or one or more of the other subsystems 202 (e.g., the HMI control devices 220).

A subsystem 202-8 is an active suspension control subsystem. One or more suspension control devices 238 implement functions of a suspension control module (SCM) to regulate suspension components to adjust the ride level of the vehicle 102. For example, suspension control devices 238 configure a vehicle suspension to be stiffer on paved surfaces for improved driving performance and maneuverability. In an offroad setting, the suspension control devices 238 enable a softer suspension setting to provide a smoother ride.

A subsystem 202-9 represents a battery management subsystem of the vehicle 102. One or more battery management devices 240 monitor the performance of a battery pack (also referred to as a traction battery) to ensure appropriate charging and discharging rates to promote longevity and overall battery health. The battery management devices 240 control charging operations of onboard vehicle batteries as well as controlling battery usage (e.g., to control a rate of discharge). The battery management devices 240 monitor the health of vehicle batteries to alert the control system 204 when a malfunction is imminent or occurs.

Finally, a subsystem 202-N is depicted in FIG. 2, representing a power distribution system. One or more power distribution devices 242 of the subsystem 202- N manage the distribution of electrical power from energy sources on the vehicle 102 to the vehicle system 200. For example, the power distribution devices 242 control power switches, inverters, converters, and other electrical distribution components to ensure the subsystems 202 receive an appropriate level of current and voltage for implementing vehicle functions. The power distribution devices 242 can include fault protection circuits and breakers to interrupt power to a faulty subsystem and maintain safe electrical conditions while the vehicle 102 remains active. The power distribution devices 242 interface with the motor/engine devices 216 and the battery management devices 240 to manage safe electrical conditions throughout the vehicle system 200.

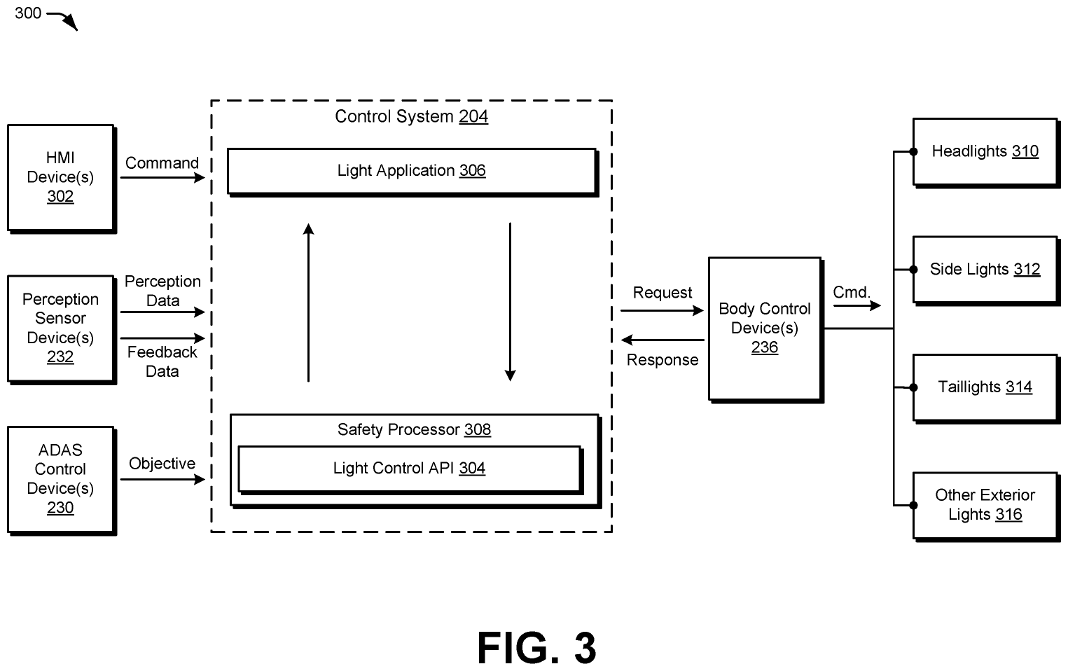

FIG. 3 depicts an example block diagram 300 for providing enhanced human interface lighting in a vehicle. The illustrated block diagram 300 includes the control system 204, ADAS control devices 230, perception sensor devices 232, and body control devices 236 of FIG. 2. The block diagram 300 also includes one or more HMI devices 302, a light control application programming interface (API) 304, a safety processor 308, a light application 306, headlights 310, side lights 312, taillights 314, and other exterior lights 316 (e.g., corner lights). It is to be appreciated that different configurations of the vehicle 102 may have different components and subsystems. For instance, a fully autonomous vehicle not configured to transport passengers may not include the HMI devices 302.

One example of the HMI device 302 is a touch screen of the vehicle 102, such as a touch screen within a passenger cabin that a driver, passenger, or other user can use. In at least one scenario, input is received via the HMI device 302 (e.g., a touch input in relation to a displayed interactive element for exterior lighting). Responsive to such input, the HMI device 302 communicates a command to the control system 204. For example, the command is provided from the vehicle subsystem (e.g., the HMI device 302) to the light application 306 and forwarded on to the body control devices 236.

In accordance with one implementation, the command from the HMI device 302 is not simply forwarded to the targeted subsystem (e.g., the body control device 236) to cause it to perform the commanded operation. Instead, the command is filtered by a safety processor 308 to ensure that performing the operation commanded by the HMI device 302 is safe or permissible given a state of the vehicle 102. To ensure the operation's safety or permissibility, the light application 306 submits a request for arbitration via the light control API 304. In one or more implementations, the light application 306 is not directly connected to one or more subsystems (or any subsystems) of the vehicle 102. Instead, the safety processor 308 is directly connected (e.g., via wired connections) to the subsystems of the vehicle 102 (e.g., there are direct physical connections between I/O ports of the safety processor 308 and the subsystems). Due to this architecture, in order to actuate a subsystem, any request or command from the HMI device 302 or the light application 306 for a subsystem to perform an operation is channeled through the safety processor 308.

The safety processor 308 and/or the light control API 304 determines whether a requested operation satisfies safety or regulatory rules. An example regulatory rule may be that many countries, states, and other territories do not allow vehicles to emit lights to the side while driving on roads. If the requested operation is determined to satisfy the safety or regulatory rules, the safety processor 308 submits a command to the body control devices 236 to perform the operation, e.g., to the headlights 310, side lights 312, taillights 314, or other exterior lights 316. If the requested operation is determined not to satisfy the safety or regulatory rules, the request is denied, and the safety processor 308 discards the request.

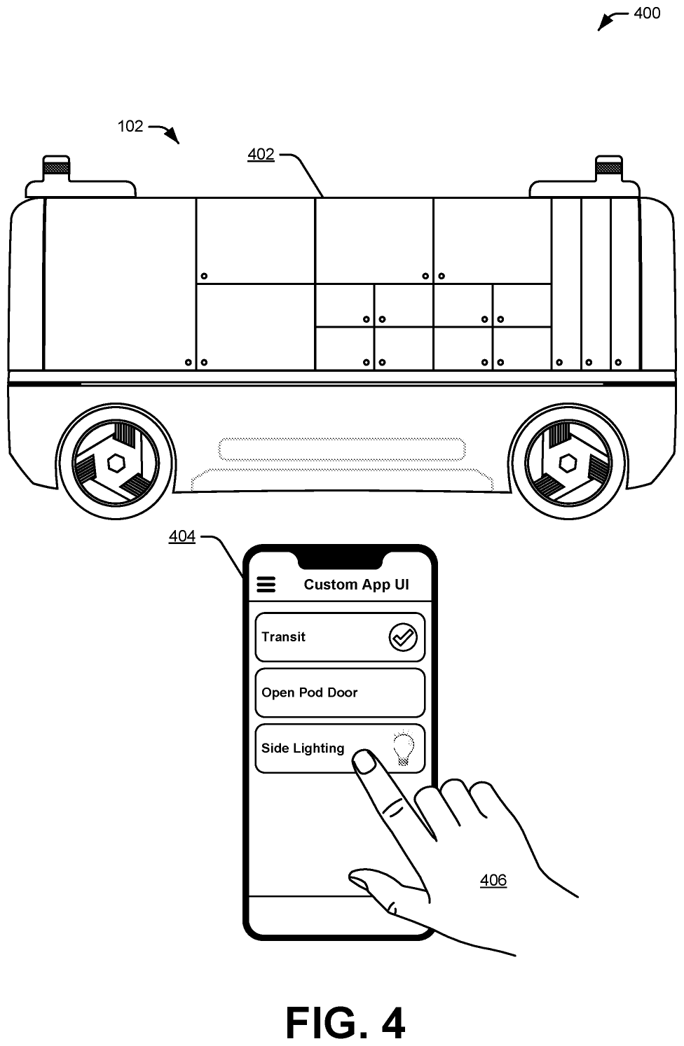

FIG. 4 is an environment 400 illustrating a non-limiting example of a vehicle system that enables enhanced human interface lighting via an application on an external computing device 404.

In particular, the environment 400 includes the vehicle 102 having a pod 402 with multiple bins or lockers. In this environment 400, the pod 402 is disposed on top of the vehicle, e.g., relative to a surface on which the vehicle travels. In one or more implementations, the pod 402 may be integral with the vehicle 102 in any of a variety of other ways, such as disposed on a side of the vehicle, beneath a body of the vehicle, and so on.

The illustrated environment 400 also includes the external computing device 404 (e.g., a smartphone with a custom app UI), which is operable by a user 406 external to the vehicle 102. This environment 400 represents a scenario where the user 406 may provide input via a user interface displayed via the external computing device 404. In this scenario, the user 406 may provide an input to the user interface for controlling some operation of the vehicle 102 and/or the pod 402. For instance, the user may provide input via the user interface for opening a door of the pod 402 or turning on side lighting (e.g., the side lighting illustrated in FIG. 1B). In accordance with the described techniques, the external computing device 404 may communicate an indication of this input to the control system 204 or the light application 306 over a network (not shown). Responsive to the receipt of the indication, the light application 306 corresponding to the companion application of the external computing device 404 may cause a request to be sent from the control system 204 to the safety processor(s) 308.

In accordance with the described techniques, the light control API 304 or the safety processor 308 then arbitrates the received request. Here, the light control API 304 determines whether turning on side lighting satisfies safety rules (e.g., the vehicle 102 is not driving on a roadway). If turning on the lights satisfies the safety rules, the operation is permitted and the safety processor 308 issues a command to the body control device 236 to turn on the side lights 312. If turning on the side lights 312 does not meet the safety rules, the operation is denied, and the safety processor 308 discards the request. Further, the safety processor 308 does not issue a command to the body control device 236 to turn on the side lights 312 in such situations.

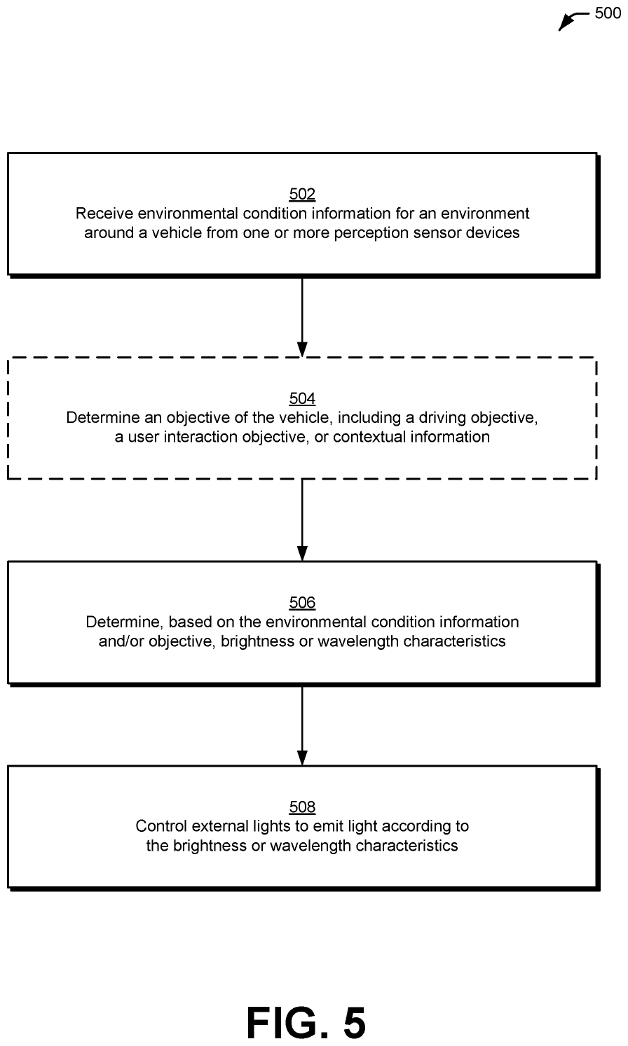

FIG. 5 depicts a procedure 500 for implementing enhanced human interface lighting for autonomous machines. The procedure 500 includes multiple operations illustrated as block 502 through block 508 and provides just one example procedure performed within any of the previously described systems (e.g., the vehicle system 104, the vehicle system 200). The procedure 500 is not limited to the order of operations shown in FIG. 5, other orderings of blocks 502 through 508 are possible. In one or more implementations, the procedure 500 includes additional or fewer operations than those depicted in FIG. 5.

The procedure 500 starts with environmental condition information for the environment around a vehicle being received from one or more perception sensor devices of the vehicle (block 502). For example, perception sensor subsystem 106 obtain environmental condition information for the environment (e.g., the environment 100-1 and 100-2), which may include the weather, surface composition, and the presence of nearby vehicles, pedestrians, and other objects. The perception sensors of the perception sensor subsystem 106 can include camera systems, radar sensors, lidar sensors, thermometers, or ambient light sensors.

Next, an objective or mission information for the vehicle is optionally determined or obtained (block 504). The objective or mission information may include at least one of a driving objective from the vehicle's autonomous-or semi-autonomous-driving system, a user interaction objective from one or more off-vehicle or on-vehicle data platforms (e.g., an e-commerce platform), or contextual information from one or more perception sensor devices or the one or more data platforms. For example, the ADAS control device 230 provides mission information or the objective to the body control device 236. The mission information and objective may include continuing to drive along a roadway, preparing to make a turn, preparing to proceed from a stopped or parked position, delivering items, the types of items being delivered, number of pedestrians nearby, user or vendor preferences, or picking up a passenger.

Brightness or wavelength characteristics for external lights are determined based on the environmental condition information and/or the objective (block 506). For example, the body control subsystem 108 determines the brightness or wavelength characteristics for one or more subsets of light emitters in the external lights 110. Different characteristics can be used for different subsets of light emitters in order to display a light path 116, display advertisements, provide ambient lighting, warn pedestrians, or communicate with other vehicles.

The external lights of the vehicle are then controlled to emit light according to the brightness or wavelength characteristics (block 508). For example, the body control device 236 causes the exterior lights 110 to emit light according to the brightness or wavelength characteristics.

Many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the vehicle system 104, perception sensor subsystem 106, body control subsystem 108, exterior lights 110) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a DSP, a GPU, a parallel accelerated processor, a plurality of microprocessors, one or more microprocessors in association with a DSP core, a controller, a microcontroller, Application Specific Integrated Circuits (ASICs), FPGAs, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a ROM, a RAM, a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
one or more perception sensor devices configured to obtain environmental condition information for an environment near a vehicle; and
a vehicle control system having one or more processors configured to control brightness or wavelength characteristics for one or more exterior lights of the vehicle based on the environmental condition information.

2. The system of claim 1, wherein:
the exterior lights include an array of multi-wavelength light emitters; and
each multi-wavelength light emitter has adjustable brightness or wavelength characteristics.

3. The system of claim 2, wherein the one or more processors are further configured to control two or more subsets of the array of multi-wavelength light emitters to emit light with different brightness or wavelength characteristics from one another.

4. The system of claim 2, wherein the array of multi-wavelength light emitters is located on at least one of a rear, front, corner, side, or bottom of the vehicle.

5. The system of claim 4, wherein:
the array of multi-wavelength light emitters is located on the front of the vehicle; and
the one or more processors are further configured to control multiple subsets of the array of multi-wavelength light emitters to emit light with different brightness or wavelength characteristics at different longitudinal distances in front of the vehicle.

6. The system of claim 4, wherein:
the array of multi-wavelength light emitters is located on the side of the vehicle; and
the one or more processors are further configured to control a subset of the array of multi-wavelength light sources to emit a light trail extending away from the side of the vehicle, provide ambient lighting, or display an advertisement on a ground surface near the vehicle.

7. The system of claim 4, wherein the one or more processors are further configured to control a subset of the array of multi-wavelength light emitters to emit a light strip on a surface near the vehicle in response to the vehicle being placed in drive or reverse, the light strip configured to provide a warning to nearby pedestrians, vehicles, or other objects that the vehicle is prepared to move.

8. The system of claim 2, wherein the multi-wavelength light emitters are configured to emit light within at least two of a visible light spectrum, an ultraviolet light spectrum, or an infrared light spectrum.

9. The system of claim 8, wherein the one or more processors are further configured to control at least a subset of the multi-wavelength light emitters to emit ultraviolet light or infrared light to communicate information to nearby vehicles regarding at least one of a status of the vehicle, an upcoming driving maneuver of the vehicle, or an obstacle in a roadway.

10. The system of claim 2, wherein each multi-wavelength light emitter is a light emitting diode.

11. The system of claim 1, wherein the one or more processors are further configured to:
obtain an objective for the vehicle, including a driving objective from an autonomous-or semi-autonomous-driving system or a user interaction objective from one or more data platforms; and
control the brightness or wavelength characteristics for the one or more exterior lights based on the environmental condition information and the objective.

12. The system of claim 1, wherein the one or more processors are further configured to:
obtain feedback data from at least one of the one or more perception sensor devices, the feedback data indicating a perception quality of recent data collections; and
control the brightness or wavelength characteristics for the one or more exterior lights based on the environmental condition information and the feedback data.

13. The system of claim 1, wherein the environmental condition information includes at least one of ambient light information, weather condition information, road surface conditions, or information regarding nearby objects.

14. The system of claim 1, wherein the one or more processors are further configured to:
in response to detecting a pedestrian crossing in front of the vehicle and an autonomous-driving subsystem determining to not proceed driving, control the one or more exterior lights to emit a light strip indicating that the vehicle notices the pedestrian and will not proceed; and
in response to detecting the pedestrian has finished crossing in front of the vehicle and the autonomous-driving subsystem determining to proceed driving, control the one or more exterior lights to emit another light strip indicating that the vehicle will proceed driving.

15. A vehicle control system of a vehicle comprising one or more processors configured to:
obtain, from one or more perception sensor devices, environmental condition information for an environment around the vehicle; and
control, based on the environmental condition information, brightness or wavelength characteristics for one or more exterior lights of the vehicle.

16. The vehicle control system of claim 15, wherein:
the exterior lights include an array of multi-wavelength light emitters, each multi-wavelength light emitter having adjustable brightness or wavelength characteristics; and
the one or more processors are further configured to control two or more subsets of the array of multi-wavelength light emitters to emit light with different brightness or wavelength characteristics from one another.

17. The vehicle control system of claim 16, wherein the one or more processors are further configured to control the array of multi-wavelength light emitters to emit light with different brightness or wavelength characteristics based on at least one of a longitudinal distance from a front of the vehicle or a lateral distance from a center of the vehicle.

18. The vehicle control system of claim 16, wherein the one or more processors are further configured to control a subset of the array of multi-wavelength light sources to emit a light trail extending away from a side of the vehicle, provide ambient lighting, or display an advertisement on a ground surface near the vehicle.

19. The vehicle control system of claim 16, wherein the one or more processors are further configured to control a subset of the array of multi-wavelength light emitters to emit a light strip on a surface near the vehicle in response to an input to open a door or rear hatch of the vehicle to provide a warning to nearby pedestrians, vehicles, or other objects that the door or the rear hatch will open.

20. A computer-readable storage medium comprising instructions that, when executed by one or more processors, cause a vehicle control system of a vehicle to:
determine an objective for the vehicle, the objective including a driving objective from one or more autonomous-or semi-autonomous driving systems, a user interaction objective from one or more data platforms, or contextual information from one or more perception sensor devices or the one or more data platforms;
determine brightness or wavelength characteristics for one or more exterior lights of the vehicle based on the objectives; and
control the one or more exterior lights to emit light according to the brightness or wavelength characteristics.
